(19) United States
(12) Patent Application Publication
(10) Pub. No.: US 2011/0313787 A1
(43) Pub. Date: Dec. 22, 2011

(54) Operating System

(76) Inventors: Vasu Rangadass, Arlington, TX (US); Ravi Seshadri, Plano, TX (US); Gregory J. Poe, Norman, OK (US)

(21) Appl. No.: 12/816,804

(22) Filed: Jun. 16, 2010

(51) Int. Cl. G06Q 10/00; G06Q 30/00; G06Q 50/00; G06F 17/30; G06F 3/048

(52) U.S. Cl. 705/3; 707/803; 715/764; 707/E17.044

(57) ABSTRACT

A new and improved operating system is described. The system enables a user to receive information in many different types of formats and converts them into a uniform format. The system can also use the information to fill out forms in different types of formats, and then send them to the appropriate recipient.

### CROSS REFERENCE TO RELATED APPLICATIONS

Applicant claims priority based on non-provisional application Ser. No. 12/536,060, filed on Aug. 5, 2009, the entire content of which is incorporated herein by reference.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a block diagram illustrating an example of an operating environment for a company; and

FIG. 2 is an example of an embodiment of the invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

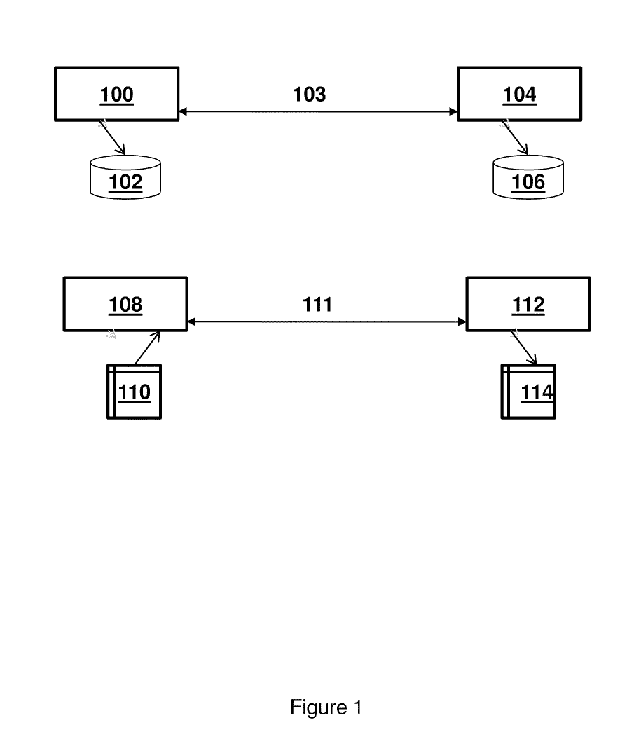

One of the most significant information technology challenges facing larger organizations today is management of forms between different systems. FIG. 1 illustrates how many companies currently do business. An employee gets electronic mail 103 through his email system 100, which in turn stores the electronic mail in a database 102. Similarly, his counter-part in another company has a similar electronic mail system 104 that stores his electronic mail in a database 106. Electronic mail can also include attachments that need to be stored or printed and then physically stored in a file.

Another method of communicating with business associates is sending a facsimile. In this example, an employee can use his facsimile machine 108 to send a facsimile 110 to a business associate's facsimile machine 112 that gets printed out 114.

Another method of communicating is through the US Mail or special physical delivery. The employee would receive the mail or package, then either scan and store electronically or physically store in a file.

A major problem with these current systems is that many of these letters, forms and other types of communication need to be scanned in and stored or retyped into another format. For example, a law office would normally mail an invoice through the traditional US Mail to a client where the client would then have to re-enter the information into their accounting package. Even if the attorney sent the invoice attached to an email, the client would then view and/or print out the invoice and then re-enter into their accounting system. Another example is when an attorney prepares a document for the client to review, if the attorney either uses a facsimile or regular mail to send the document, the client may then have to scan in the document and/or convert into another format the change and then send his comments back to the attorney. Another example is when a clinic sends lab results to a doctor, the doctor then most likely has to convert it to another format to be used in his practice. Thousands of more examples exist where one business document has be converted into another format to be used in a different system.

One major solution is using Electronic Data Interchange (EDI) system. EDI refers to the structured transmission of data between organizations by electronic means. It is used to transfer electronic documents from one computer system to another, i.e. from one business to another business partner. However, the system encompasses more than mere email; for example, organizations might replace bills of lading and even checks with appropriate EDI messages. It also refers specifically to a family of standards, including the X12 series. However, EDI also exhibits its pre-Internet roots, and the standards tend to focus on ASCII (American Standard Code for Information Interchange)—formatted single messages rather than the whole sequence of conditions and exchanges that make up an inter-organization business process.

There are many barriers to adopting EDI system. One of the most significant barriers is the cost in time and money in the initial set-up. The preliminary expenses and time that arise from the implementation, customization and training can be costly and therefore may discourage some businesses.

Therefore, what is needed is an efficient method on converting an incoming communication into a typical environment of the business. For example, if the system that a doctor's office uses could convert lab results for a patient into pieces of information that could then be used to order a prescription from a pharmacy for the correct medicine for that same patient.

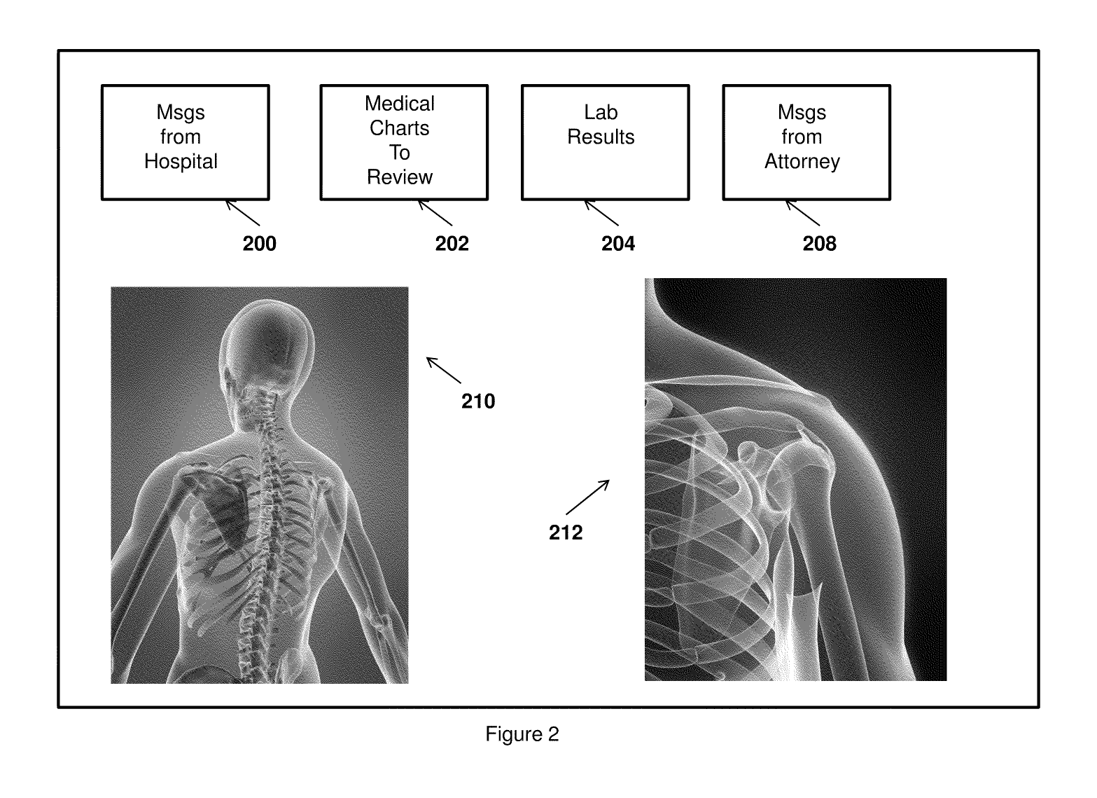

One embodiment of the present invention contemplates such a system. The system includes an improved operating system that presents a user with an integrated interface that presents all the information a user receives, reviews, edits and sends out, in ubiquitous form. FIG. 2 illustrates and example of how such a system might appear. At the top of the screen, 4 windows are configured in a dashboard-like manner. Module 200 represents messages that the doctor receives from the hospital. The hospital may send the messages by facsimile, email or by standard mail, but the messages get converted to a uniform format and automatically get routed to the correct doctor's desktop without the doctor having to access email or the facsimile machine.

Module 202 represents any medical charts that the doctor has to review. For example, the doctor could open up the medical charts module 202 and want to review the upper body x-ray 210 or an x-ray 212 that focuses on the left shoulder. The medical charts of each patient also include other information such as medical history, prescriptions, and recent lab results. All of the information in the medical charts may come from different sources in different formats. For example, the recent lab results may be received via fax, but the system converts the information so that the doctor can order a prescription based off the lab results and automatically send the appropriate information for that patient to the pharmacy.

Module 204 represents recent lab results for different patients that the doctor needs to review. The doctor would then review the lab results and if he choose to, the lab results would automatically update the medical charts of each patient.

In addition, module 208 represents messages from the doctor's attorney that needs his review. For example, the messages could include a patent application that the doctor needs to review. The doctor would then review the document and then send his comments to the attorney. Another example is when the attorney sends an invoice, the doctor would review the invoice and then the system would automatically convert the invoice and insert the information into the doctor's accounting system for payment.

Moreover, the system can also pull the proper information for a patient's treatment and fill out the proper form to send to Medicaid for payment. Similarly, the system can fill out other insurance companies' forms and submit them for payment. Further, the system can send the appropriate tax information to the accountant in the accountant's format. In addition, the system is adaptable to be customized for a clinic, hospital, law office, accounting firm, banks, hotel, health spa and many more types of businesses.

In sum, the system can receive information in various formats from many different businesses and convert them into pieces of information that can then be reassembled into many different types of forms. Ideally, the interacting businesses have the same or similar system so that each business would send and receive information and it would show up directly on the user's desktop.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. An operating system that converts data from a plurality of formats, the system comprising:
a module for receiving data in a plurality of formats;
a storage for storing data;
a display for displaying information;
a module for converting data from the plurality of formats; and
a module for sending the data in at least one of the plurality of formats.

2. The operating system of claim 1 wherein the data is at least one of the following group:
emails, faxes, electronic data information, and attachments in electronic formats.

3. The operating system of claim 1 wherein the display includes a dashboard with a plurality of icons.

4. The operating system of claim 1 wherein the display includes x-rays of a patient.

5. The operating system of claim 1 wherein the display includes medical charts of a patient.

6. The operating system of claim 1 further comprising an application services module for providing an authoritative identifier of healthcare providers and basic demographic information within the operating system.

7. The operating system of claim 1 further comprising a data services module for data administration which provides the ability to maintain data stored within a plurality of modules within the operating system.

8. The operating system of claim 1 wherein the data received is converted and sent in a proper format to invoice Medicare.

9. The operating system of claim 1 wherein the data received is converted and sent in a proper format to a pharmacy.

10. The operating system of claim 1 wherein the data received is converted and sent in a proper format to a hospital.

11. An operating system that converts data from a plurality of formats, the system comprising:
a monitoring and routing module;
an operating system workflow module connected with the monitoring and routing module;
a virtual data layer and discovery module receives data in a plurality of formats;
an operating system database that stores the data;
a conversion module that converts the data into at least one of the plurality of formats; and
a transmission module that sends out the data in the at least one of the plurality of formats; wherein each module comprises self-contained service layers coupled together and all modules are interconnected.

12. The operating system of claim 11 wherein the data is at least one of the following group: emails, faxes, electronic data information, and attachments in electronic formats.

13. The operating system of claim 11 wherein the display includes a dashboard with a plurality of icons.

14. The operating system of claim 11 wherein the display includes x-rays of a patient.

15. The operating system of claim 11 wherein the display includes medical charts of a patient.

16. The operating system of claim 11 further comprising an application services module for providing an authoritative identifier of healthcare providers and basic demographic information within the operating system.

17. The operating system of claim 11 further comprising a data services module for data administration which provides the ability to maintain data stored within a plurality of modules within the operating system.

18. The operating system of claim 11 wherein the data received is converted and sent in a proper format to invoice Medicare.

19. The operating system of claim 11 wherein the data received is converted and sent in a proper format to a pharmacy.

20. The operating system of claim 11 wherein the data received is converted and sent in a proper format to a hospital.
